(19) United States
(12) Patent Application Publication
(10) Pub. No.: US 2011/0055612 A1
(43) Pub. Date: Mar. 3, 2011

(54) COMPUTER SYSTEM AND CONTROL METHOD THEREOF

(75) Inventor: Tae-hoon LEE, Gyeonggi-do (KR)

(73) Assignee: SAMSUNG ELECTRONICS CO., LTD., Gyeonggi-Do (KR)

(21) Appl. No.: 12/845,938

(22) Filed: Jul. 29, 2010

(30) Foreign Application Priority Data
Aug. 25, 2009 (KR) 10-2009-0078816

(51) Int. Cl. G06F 1/32

(52) U.S. Cl. 713/324

(57) ABSTRACT

A computer system and a control method thereof reduce power to devices not in use. The system typically includes a device unit; a switching unit which switches supply of power to the device unit; and a control unit which checks whether or not the device unit is in use, and controls the switching unit to prevent power from being supplied to the device unit if the device unit is not in use. Wasteful power consumed by devices which are not in use is minimized. In addition, if a user wants to reuse a device with supply of power cut off, it is possible to reuse the device by resuming the supply of power to the device in a simple manner.

### CLAIM OF PRIORITY

This application claims the benefit of priority from Korean Patent Application No. 10-2009-0078816, filed on Aug. 25, 2009 in the Korean Intellectual Property Office, the disclosure of which is incorporated herein by reference in its entirety.

### BACKGROUND OF THE INVENTION

1. Field of the Invention

The present invention relates to a computer system and a control method thereof. More particularly, the present invention relates to a computer system including devices which are in nonpersistent use, and a control method thereof.

2. Description of the Related Art

Computer systems, such as desktop computers, laptop computers, tablet computers, notebook computers and so on, may contain different devices, such as a keyboard, a hard disk drive (HDD), an optical (ODD) and so on, whose characteristics may be differentiated in terms of persistency of use.

For example, a keyboard which receives an input from a user, a HDD in which an operating system (OS) and so on are installed, and a network adapter which is connected to and communicates with a network have “use persistency” as they have to continue to operate except in a special case.

On the contrary, unlike the above-mentioned devices, a secondary HDD or ODD as an auxiliary storage device may not always have use persistency since such secondary or auxiliary devices are often temporarily used in many cases, as necessity by a user.

In addition, power is still being supplied to such devices with little or no use persistency in preparation for some potential use without introducing unnecessary delay. However, such a device consumes a minimum of power for a basic operation even when it is in no use, which leads to wasteful power consumption.

In particular, since a portable computer system such as a laptop computer relies on a battery, which is a limited power supply, for supply of power to the system, wasteful power consumption of the system may cause a significant problem.

### SUMMARY OF THE INVENTION

Accordingly, one or more exemplary embodiments of the present invention provide a computer system which minimizes wasteful power consumed by devices which are not in use, and a control method thereof.

Another exemplary embodiment of the present invention is to provide a computer system which allows a device with its power cut off to be reused in a simpler manner, and a control method thereof.

The foregoing and/or other exemplary aspects may be achieved by providing a computer system preferably including: a device unit; a switching unit which switches supply of power to the device unit; and a control unit which checks whether or not the device unit is in use, and controls the switching unit to prevent power from being supplied to the device unit when the device unit is not in use.

The device unit may store data in a demountable storage medium, and the control unit may determine that the device unit is not in use if the storage medium is not mounted on the device unit.

The control unit may check whether or not the device unit is in use in at least one of a case where the computer system is booted and a case where the computer system returns from a sleep mode to a normal mode.

The control unit may determine that the device unit is not in use if the device unit performs no data input/output.

The device unit may also include a main device unit and a secondary device unit which assists the main device unit, and the control unit may control the switching unit to maintain a supply of power to the main device unit and prevent power from being supplied to the secondary device unit.

The control unit may check whether or not the device unit is in use, with supply of power to the device unit cut off, and control the switching unit to resume the supply of power to the device unit.

The computer system may further include a user input unit which receives an instruction from a user, and the control unit may determine whether to use the device unit based on the user instruction received by the user input unit.

The foregoing and/or other exemplary aspects may be achieved by providing a control method of a computer system, including: checking whether a device unit is in use; and cutting off supply of power to the device unit to prevent power from being supplied to the device unit if the device unit is not in use.

The device unit may store data in a demountable storage medium, and the checking may include determining that the device unit is not in use if the storage medium is not mounted on the device unit.

The checking may include checking whether the device unit is in use in at least one of a case where the computer system is booted and a case where the computer system returns from a sleep mode to a normal mode.

The checking may also include determining that the device unit is not in use if the device unit performs no data input/output.

The device unit may include a main device unit and a secondary device unit which assists the main device unit, and the cutting off may include maintaining supply of power to the main device unit and preventing power from being supplied to the secondary device unit.

The control method may further include checking whether the device unit is in use, with supply of power to the device unit cut off, and resuming the supply of power to the device unit.

The resuming the supply of power the control unit may include determining whether to use the device unit based on an instruction from a user.

According to an exemplary embodiment of the present invention, it is possible to minimize wasteful power consumed by devices which are not in use.

According to another exemplary embodiment of the present invention, if a user wants to reuse a device with supply of power cut off, it is possible to reuse the device by resuming the supply of power to the device in a simple manner.

### BRIEF DESCRIPTION OF THE DRAWINGS

The above and/or other exemplary aspects will become apparent to a person of ordinary skill in the art and more readily appreciated from the following description of the exemplary embodiments, taken in conjunction with the accompanying drawings, in which:

FIG. 1 is a block diagram showing a configuration of a computer system according to an exemplary embodiment of the present invention;

FIG. 2 is a circuit diagram showing a switching unit according to an exemplary embodiment of the present invention;

FIG. 3 is a flow chart illustrating an operation of the computer system according to an exemplary embodiment of the present invention;

FIG. 4 is a flow chart illustrating details of an operation of the computer system according to an exemplary embodiment of the present invention;

FIG. 5 is a flow chart illustrating details of an operation of the computer system according to an exemplary embodiment of the present invention;

FIG. 6 is a flow chart illustrating details of an operation of the computer system according to an exemplary embodiment of the present invention; and

FIG. 7 is a block diagram showing a configuration of a computer system according to another exemplary embodiment of the present invention.

### DETAILED DESCRIPTION

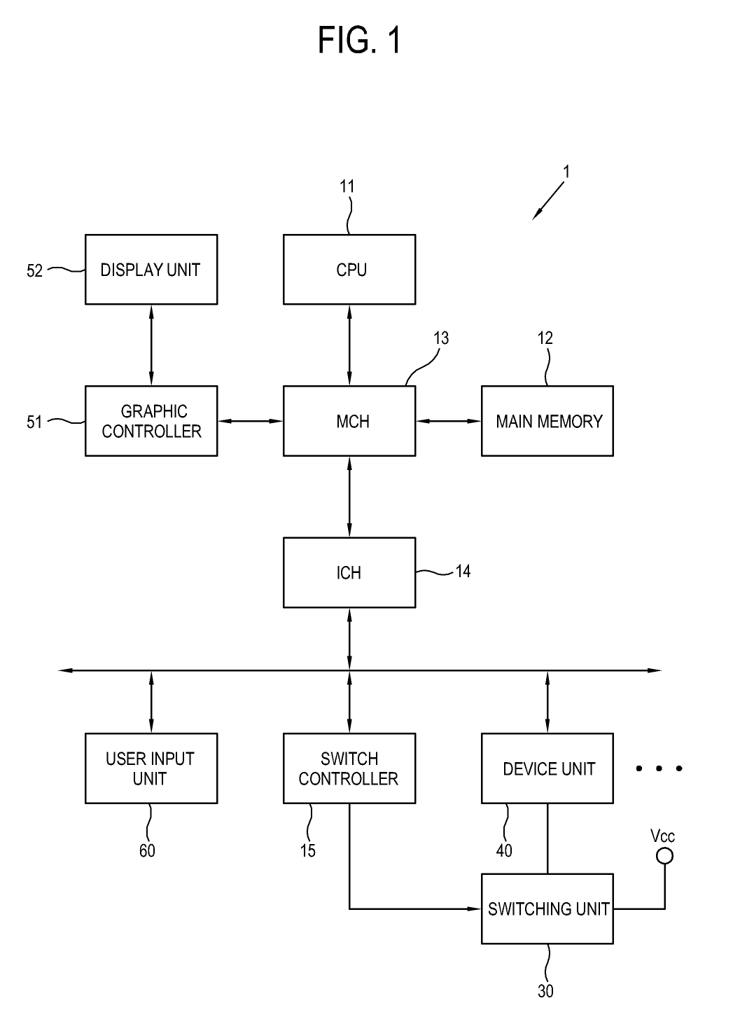

Below, exemplary embodiments will be described in detail with reference to accompanying drawings so as to be easily realized by a person having ordinary knowledge in the art. FIG. 1 is a block diagram showing a configuration of a computer system according to one exemplary embodiment of the present invention. A computer system 1 shown in FIG. 1 may be implemented by a typical personal computer (PC) such as a laptop computer or a desktop computer, or any type of devices with the same functionality as such a PC.

As shown in FIG. 1, the computer system 1 may include, for example, a central processing unit (CPU) 11, a main memory 12, a memory controller hub (MCH) 13, an input/output (I/O) controller hub (ICH) 14 and a device unit 40.

The CPU 11 controls the entire operation of the computer system 1 and executes computer programs loaded in the main memory 12. In executing these computer programs, the CPU 11 may communicate with and control the MCH 13, the ICH 14 and the device unit 40.

The main memory 12 temporarily stores data related to the operation of the CPU 11, including the computer programs executed by the CPU 11. The main memory 12 may be implemented by a volatile memory such as, for example, a double-data-rate synchronous dynamic random access memory (DDR SDRAM). However, many other types of memory can be used. The device unit 40 includes certain functions and may be implemented by any type of devices such as a HDD, an ODD, a CD-ROM, a DVD-ROM, a USB drive, a modem, a network adapter, a sound card, a speaker, a microphone or the like just to name a few possibilities. For the sake of convenience of illustration, FIG. 1 shows a single device unit 40, but the computer system 1 according to one exemplary embodiment of the present invention may include a plurality of device units 40.

The MCH 13 interfaces data read and write between the main memory 12 and other components such as the CPU 11 and so on. The ICH 14 connects the CPU 11 to the device unit 40 and controls input/output of the device unit 40.

In this exemplary embodiment, the computer system 1 may further include a graphic controller 51 and a display unit 52. The graphic controller 51 processes graphic data for displaying an image and the display unit 52 displays the image based on the graphic data processed by the graphic controller 51. The display unit 51 may be implemented by a liquid crystal display (LCD), an organic light emitting diode (OLED), or any type of thin-film technology or the like. If the computer system 1 is of a desktop type, the display unit 52 may be provided as a separate device such as a monitor. In this exemplary embodiment, although not shown in FIG. 1, the computer system 1 may further include a power supply unit which supplies an operation voltage to each component.

In this exemplary embodiment, the computer system 1 may further include a switching unit 30 and a switch controller 15. The switching unit 30 is arranged on a power supply path of the device unit 40 and switches supply of power to the device unit 40. The switch controller 15 controls the switching operation of the switching unit 30 in association with various situations through communication with the ICH 14. The switch controller 15 may be implemented by a single IC including a special purpose microprocessor which executes a predetermined program, a memory, a data bus and so on.

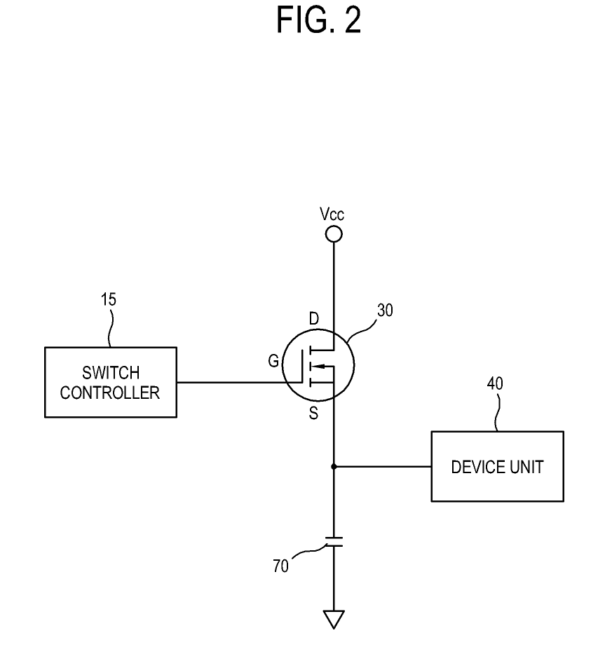

FIG. 2 is a circuit diagram showing the switching unit according to an exemplary embodiment of the present invention. As shown in FIG. 2, in this exemplary embodiment, the switching unit 30 may be implemented by a MOSFET. In this exemplary embodiment, the MOSFET 30 includes a drain D connected to an operation voltage Vcc and a source S connected to a capacitor 70. A power input terminal of the device unit 40 is connected to the source S of the MOSFET 30 and may receive the operation voltage Vcc when the MOSFET 30 is turned on.

In addition, the MOSFET 30 includes a gate G which is connected to the switch controller 15 and receives a control signal from the switch controller 15. The switch controller 15 outputs the control signal to the MOSFET 30 such that the MOSFET 30 is turned on when power is to be supplied to the device unit 40, whereas the MOSFET 30 is turned off when no power is to be supplied to the device unit 40.

According to this exemplary embodiment, the CPU 11, the MCH 13, the ICH 14 and the switching controller 15 shown in FIG. 1 constitutes hardware of a control unit. Hereinafter, a reference numeral for the control unit in this exemplary embodiment will be omitted for the sake of convenience. In this embodiment, in addition to such a hardware configuration, the control unit may further include a software configuration including at least one of a basic input/output system (BIOS), an operating system (OS) and applications. The BIOS may be stored in a BIOS ROM (not shown) which is a nonvolatile memory and the OS and the applications may be stored in the device unit 40 such as, for example, a HDD.

The control unit checks whether or not the device unit 40 is used. If the device unit 40 is not in use, the control unit controls the switching unit 30 such that the operation voltage Vcc is not supplied to the device unit 40. For example, assume that the computer system 1 further includes a secondary HDD or ODD in addition to a basic HDD as the device unit 40 in which the OS and so on are installed. In addition, connectivity between the secondary HDD or ODD and the ICH 14 may comply with a serial advanced technology attachment (SATA) interface standard.

The secondary HDD or ODD may not be persistently used under some use conditions of a user, unlike the basic HDD. Moreover, the control unit monitors the use conditions on the secondary HDD or ODD. If it is determined that the secondary HDD or ODD is in no use, the control unit controls the switching unit 30 such that the operation voltage Vcc is not supplied to the secondary HDD or ODD.

More specifically, in this exemplary embodiment, the BIOS may inquire of the OS about the use conditions of the secondary HDD or ODD through the ICH 14. In addition, the BIOS may control supply of power to the secondary HDD or ODD through corresponding pins of the switching controller 15. If the secondary HDD or ODD complies with a SATA interface standard which supports a hot-plug function, when the secondary HDD or ODD is separated from the computer system 1, information on such separation is delivered to the ICH 14 and the OS. In addition, the secondary HDD or ODD is merely one example of the device unit 40 whose power is cut off when it is not in use, but the device unit 40 may exist in many different forms.

As described above, according to this exemplary embodiment, it is possible to minimize wasteful power consumption by preventing power from being supplied to the device unit 40 which is not in use, such as the secondary HDD or ODD.

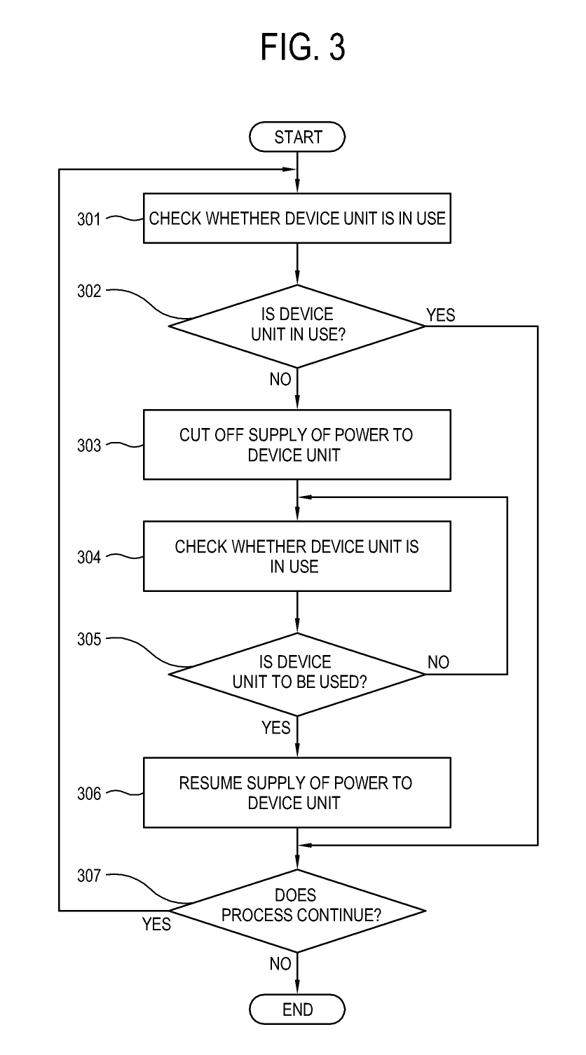

Hereinafter, the computer system 1 according to an exemplary embodiment of the present invention will be described in more detail with reference to FIGS. 3 to 6. FIG. 3 is a flow chart illustrating an operation of the computer system 1 according to an exemplary embodiment of the present invention.

First at (301), the control unit of the computer system 1 according to this embodiment checks whether or not the device unit 40 is in use.

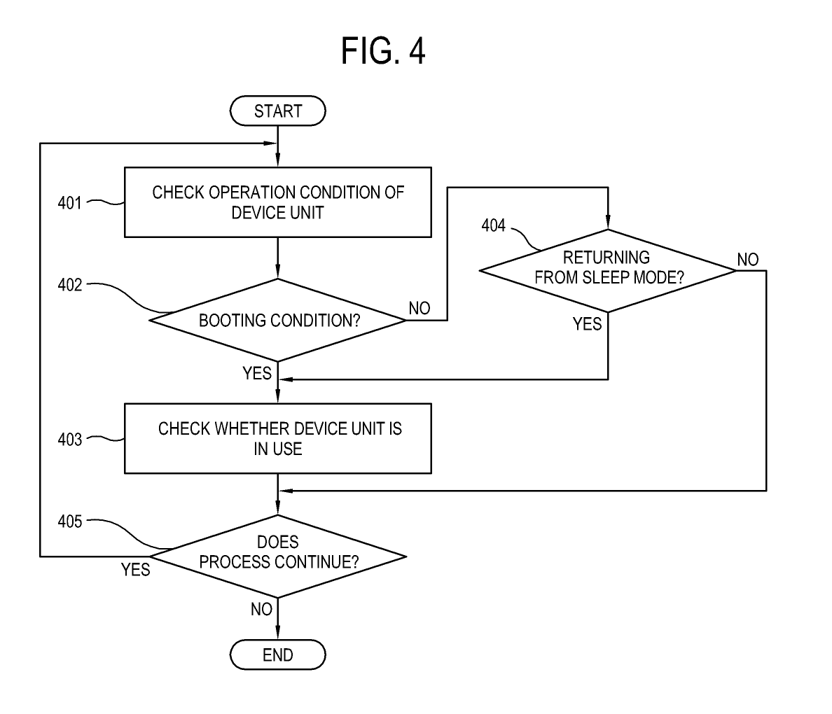

In connection with operation 301 in FIG. 3, the control unit may check whether or not the device unit 40 is in use in association with various situations. FIG. 4 is a flow chart illustrating details of an operation of the computer system 1 according to one exemplary embodiment of the present invention.

As shown in FIG. 4, at (401), the control unit checks an operation condition of the computer system 1. Subsequently, at (402), the control unit checks whether or not the operation condition of the computer system 1 is a booting condition. If it is checked in operation 402 that the operation condition of the computer system 1 is the booting condition, at (403) the control unit checks whether or not the device unit 40 is in use.

On the other hand, if it is checked in operation 402 that the operation condition of the computer system 1 is not the booting condition, at (404) the control unit checks whether or not the operation condition of the computer system 1 is a condition where the computer system 1 returns from a sleep mode to a normal mode. If it is checked in operation 404 that the operation condition of the computer system 1 is a condition where the computer system 1 returns from a sleep mode to a normal mode, at (403) the control unit checks whether or not the device unit 40 is in use.

After operation 403 is performed or if it is checked in operation 404 that the operation condition of the computer system 1 is not the condition where the computer system 1 returns from the sleep mode to the normal mode, at (405) the control unit checks whether or not the process continues. If it is checked that the process continues, operations 401 to 404 are repeated. Otherwise, the process is ended.

As an alternative exemplary embodiment, the determination (402) on whether or not the operation condition of the computer system 1 is the booting condition and the determination (404) on whether or not the operation condition of the computer system 1 is the condition where the computer system 1 returns from the sleep mode to the normal mode may be reversed in order, or it may be checked whether or not the device unit 40 is in use only in one of these determinations.

In this exemplary embodiment, the determination (402) on the booting condition and the determination (404) on the returning from the sleep mode to the normal mode are merely examples of the determination whether or not the device unit 40 is in use, but the control unit may make such a determination in different ways without departing from the spirit and scope of the claimed invention.

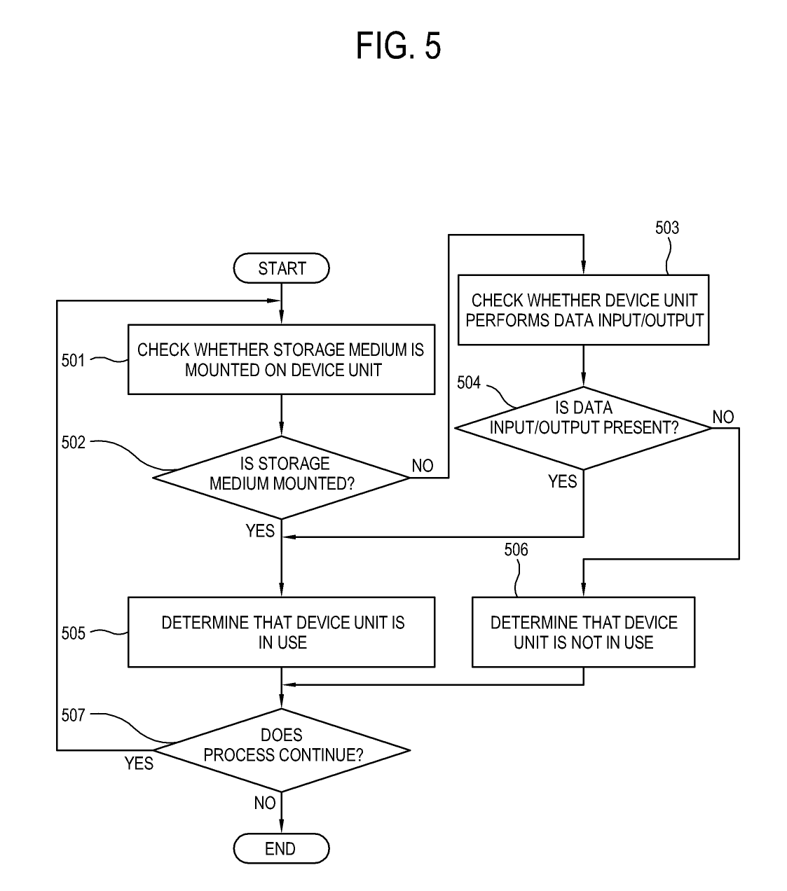

In connection with operation 301 in FIG. 3, in this embodiment, the control unit may check whether or not the device unit 40 is in use, in various ways. FIG. 5 is a flow chart illustrating details of an operation of the computer system 1 according to an exemplary embodiment of the present invention. The device unit 40 in this exemplary embodiment shown in FIG. 5 includes a storage device which stores data in a demountable storage medium. For example, in this exemplary embodiment, the storage device may be an ODD in which case the storage medium may be an optical disk.

First, as shown in FIG. 5, at (501) the control unit checks whether or not the storage medium is mounted on the storage device as the device unit 40. If it is checked in operation 501 that the storage medium is mounted on the storage device (YES in operation 502), at (505) the control unit determines that the storage device is in use.

On the other hand, if it is checked in operation 502 that the storage medium is not mounted on the storage device (NO in operation 502), at (503) the control unit checks whether or not the device unit 40 performs data input/output. If the device unit 40 complies with a SATA interface standard, it may be checked in operation 503 whether or not the device unit 40 performs data input/output based on the standard.

If it is checked in operation 503 that the device unit 40 performs data input/output (YES in operation 504), the control unit determines that the device unit 40 is in use (505). On the other hand, if it is checked in operation 503 that the device unit 40 does not perform data input/output (NO in operation 504), at (506) the control unit determines that the device unit 40 is not in use.

After operation 505 or operation 506 is performed, at (507) the control unit checks whether or not the process continues. If it is checked that the process continues, operations 501 to 506 are repeated. Otherwise, the process is ended.

As an alternative exemplary embodiment, the determination (501 and 502) on whether or not the storage medium is mounted on the storage device and the determination (503 and 504) on whether or not the device unit 40 performs data input/output may be reversed in order, or only one of these determinations may be used. In this embodiment, the determination (501 and 502) on the mounting of the storage medium and the determination (503 and 504) on the performance of data input/output are merely examples of the determination whether or not the device unit 40 is in use, but the control unit may make such a determination in different ways without departing from the spirit and scope of the invention. For example, with setting information stored by performing user setting related to use of the device unit 40, it may be determined based on the stored setting information whether or not the device unit 40 is in use.

Returning to FIG. 3, if it is checked in operation 301 that the device unit 40 is in use (YES in operation 302), the control unit performs operation 307. On the other hand, if it is checked in operation 301 that the device unit 40 is in no use (NO in operation 302), at (303) the control unit cuts off supply of power to the device unit 40.

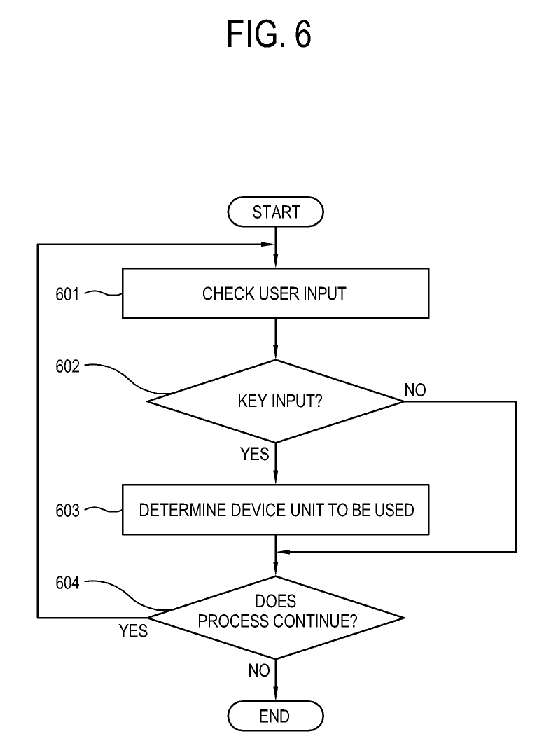

With the supply of power to the device unit 40 cut off, at (304) the control unit checks whether or not the device unit 40 is to be used. FIG. 6 is a flow chart for explaining details of an operation of the computer system 1 according to one exemplary embodiment of the present invention. Referring again to FIG. 1, the computer system 1 of this embodiment further includes a user input unit 60 which receives an input from a user. The user input unit 60 may be implemented by a keyboard, a mouse, a touch pad or the like.

As shown in FIG. 6, first, at (601) the control unit checks whether or not the user input unit 60 receives an input from a user. If it is checked in operation 601 that the user input unit 60 receives the user input through a key (YES in operation 602), at (603) the control unit may determine that the device unit 40 is to be used. In operation 602, in this exemplary embodiment, the user input through the key includes not only any key input on a keyboard but also any action using a mouse or a touch pad.

After operation 603 is performed or if it is checked in operation 601 that the user input unit 60 does not receive the user input through a key (NO in operation 602), at (604) the control unit checks whether or not the process continues. If it is checked that the process continues, operations 601 to 603 are repeated. Otherwise, the process is ended.

Returning now to FIG. 3, if it is checked in operation 304 that the device unit 40 is to be used (YES in operation 305), the control unit resumes supply of power to the device unit 40. After operation 306 is performed or if it is checked in operation 301 that the device unit 40 is not in use (NO in operation 302), the control unit checks whether or not the process continues (307). If it is checked that the process continues, operations 301 to 306 are repeated. Otherwise, the process is ended.

Thus, according to this exemplary embodiment, by resuming supply of power to a device unit when a user wants to reuse the device unit, while cutting off the supply of power to the device unit, thereby minimizing wasteful power consumption, when the device unit is not in use, the device unit can be used with no trouble. In other words, according to this embodiment, even for a device unit with power cut off, if a user wants to reuse the device unit, power can be again supplied to the device unit with simple manipulation.

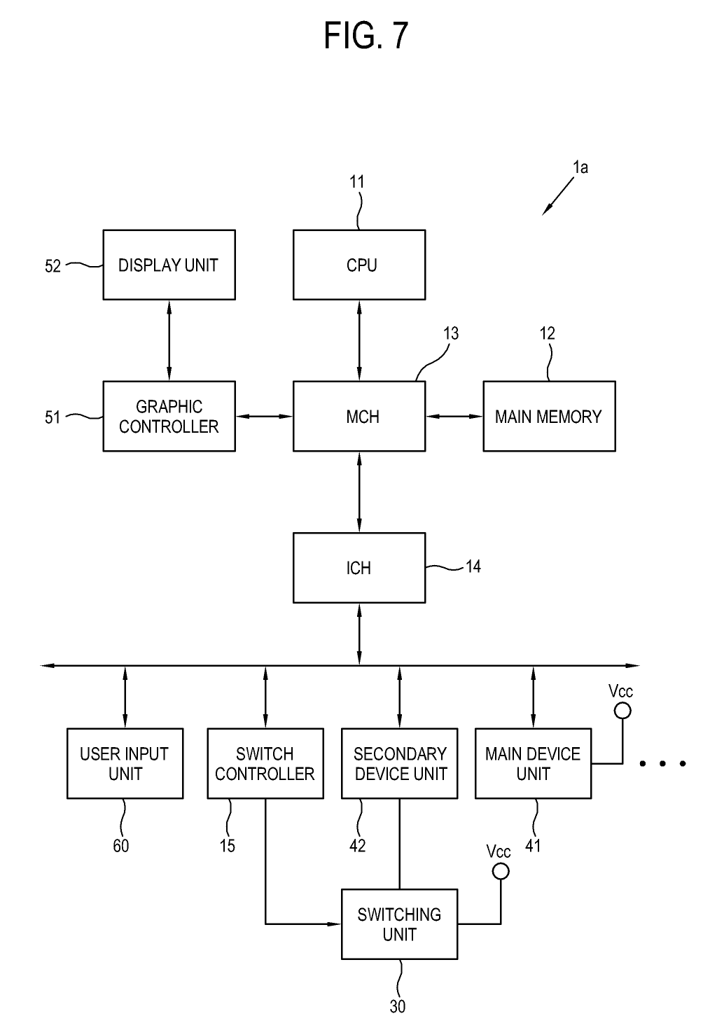

Hereinafter, a computer system according to another exemplary embodiment of the present invention will be described with reference to FIG. 7. FIG. 7 is a block diagram showing a configuration of a computer system according to another exemplary embodiment of the present invention. In connection with a computer system 1a shown in FIG. 7, explanation about the same or similar configuration as the computer system 1 shown in FIGS. 1 to 6 will be omitted for the purpose of clarity.

In this exemplary embodiment, the computer system 1a includes a plurality of device units, for example, a main device unit 41 and a secondary device unit 42. In this exemplary embodiment, the main device unit 41 may have a persistent use property such as in a basic HDD in which an OS is installed. The secondary device unit 42 assists the main device unit 41 and may be implemented by a secondary HDD, ODD or the like.

The switching unit 30 is arranged on a power supply path of the secondary device unit 42 and switches supply of an operation voltage Vcc to the secondary device unit 42. In this exemplary embodiment, the control unit checks whether or not the secondary device unit 42 is in use. If it is checked that the secondary device unit 42 is not in use, the control unit controls the switching unit 30 such that the operation voltage Vcc is not supplied to the secondary device unit 42. In this case, the operation voltage Vcc continues to be supplied to the main device unit 41.

The above-described methods according to the present invention can be realized in hardware or as software or computer code that can be stored in a recording medium such as a CD ROM, an RAM, a floppy disk, a hard disk, or a magneto-optical disk or downloaded over a network for storage on a medium such as one of the aforementioned, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A computer system comprising:
a device unit;
a switching unit which switches on and off a supply of power to the device unit; and
a control unit which checks whether or not the device unit is in use, and controls the switching unit to prevent power from being supplied to the device unit when the device unit is not in use.

2. The computer system according to claim 1, wherein the device unit stores data in a demountable storage medium, and
wherein the control unit determines that the device unit is not in use when the storage medium is not mounted on the device unit.

3. The computer system according to claim 1, wherein the control unit checks whether or not the device unit is in use in at least one of: when the computer system is booted and when the computer system returns from a sleep mode to a normal mode.

4. The computer system according to claim 1, wherein the control unit determines that the device unit is not in use if the device unit performs no data input/output.

5. The computer system according to claim 1, wherein the control unit determines that the device unit is not in use if the device unit performs no data input/output for a predetermined period of time.

6. The computer system according to claim 2, wherein the storage medium is an optical disk and the device unit comprises an optical disk drive (ODD).

7. The computer system according to claim 1, wherein the device unit comprises at least one of a hard disk drive (HDD), a CD-ROM, a DVD-ROM, a USB drive, a modem, a network adapter, a sound card, and a speaker.

8. The computer system according to claim 1, wherein the device unit includes a main device unit and a secondary device unit which assists the main device unit, and
wherein the control unit controls the switching unit to maintain supply of power to the main device unit and prevents power from being supplied to the secondary device unit.

9. The computer system according to claim 1, wherein the control unit checks whether the device unit is in use, with supply of power to the device unit cut off, and controls the switching unit to resume the supply of power to the device unit.

10. The computer system according to claim 9, further comprising a user input unit which receives an instruction from a user,
wherein the control unit determines whether to use the device unit based on the user instruction received by the user input unit.

11. A control method of a computer system, comprising:
checking whether a device unit is in use; and
cutting off a supply of power to the device unit to prevent power from being supplied to the device unit if the device unit is not in use.

12. The control method according to claim 11, wherein the device unit stores data in a demountable storage medium, and
wherein the checking includes determining that the device unit is not in use when the storage medium is not mounted on the device unit.

13. The computer system according to claim 12, wherein the storage medium is an optical disk and the device unit comprises an optical disk drive (ODD).

14. The computer system according to claim 12, wherein the device unit comprises at least one of a hard disk drive (HDD), a CD-ROM, a DVD-ROM, a USB drive, a modem, a network adapter, a sound card, and a speaker.

15. The control method according to claim 11, wherein the checking includes checking whether or not the device unit is in use in at least one of: when the computer system is booted and when the computer system returns from a sleep mode to a normal mode.

16. The control method according to claim 11, wherein the checking includes determining that the device unit is not in use when the device unit performs no data input/output.

17. The control method according to claim 11, wherein the control unit determines that the device unit is not in use if the device unit performs no data input/output for a predetermined period of time.

18. The control method according to claim 11, wherein the device unit includes a main device unit and a secondary device unit which assists the main device unit, and
wherein the cutting off includes maintaining a supply of power to the main device unit and preventing power from being supplied to the secondary device unit.

19. The control method according to claim 11, further comprising checking whether or not the device unit is in use, with supply of power to the device unit cut off, and resuming the supply of power to the device unit.

20. The control method according to claim 19, wherein the resuming the supply of power includes determining whether to use the device unit based on an instruction from a user.
